(19) United States
(12) Patent Application Publication
(10) Pub. No.: US 2018/0120148 A1
(43) Pub. Date: May 3, 2018

(54) Method And Apparatus For Detection Of Broken Piezo Material Of An Ultrasonic Transducer Of An Ultrasonic Stack

(71) Applicant: Branson Ultrasonics Corporation, Danbury, CT (US)

(72) Inventor: Scott CALDWELL, New Milford, CT (US)

(73) Assignee: Branson Ultrasonics Corporation, Danbury, CT (US)

(21) Appl. No.: 15/700,702

(22) Filed: Sep. 11, 2017

Related U.S. Application Data
(60) Provisional application No. 62/416,418, filed on Nov. 2, 2016.

(51) Int. Cl. G01H 11/08

(52) U.S. Cl. CPC G01H 11/08

(57) ABSTRACT

A broken piezoelectric material in an ultrasonic transducer of an ultrasonic stack of an ultrasonic device is detected by measuring a test piezo coupling constant with a test scan of the ultrasonic stack. The test piezo coupling constant is compared to a previously measured baseline piezo coupling constant. The piezoelectric material is determined to be broken when the test piezo coupling constant is less than the baseline piezo coupling constant by more than a predetermined amount.

### CROSS-REFERENCE TO RELATED APPLICATIONS

This application claims the benefit of U.S. Provisional Application No. 62/416,418 filed Nov. 2, 2016. The entire disclosure of the above application is incorporated herein by reference.

### FIELD

The present disclosure relates to ultrasonic devices having an ultrasonic stack, and more particularly, to detecting that the piezoelectric material of an ultrasonic transducer of the ultrasonic stack is broken.

### BACKGROUND

This section provides background information related to the present disclosure which is not necessarily prior art.

Certain ultrasonic devices have an ultrasonic stack excited by a power supply, which is often also used to control the ultrasonic device. An ultrasonic stack includes an ultrasonic transducer and any component ultrasonically coupled to the ultrasonic transducer, typically a booster and an ultrasonic horn. Examples of such ultrasonic devices include ultrasonic welders such as those used to weld together metal parts, those used to weld together plastic parts, and those used to seal ends of metal or plastic tubes (which are essentially the same as those used to weld together metal or plastic parts).

FIG. 1 shows a model of an ultrasonic stack 102 and power supply 104 of a typical ultrasonic device 100. It should be understood that ultrasonic device 100 can be any type of ultrasonic device that has an ultrasonic stack excited by a power supply. Typical components of ultrasonic stack 102 include an ultrasonic transducer 106, a booster 108 and an ultrasonic horn 110. Ultrasonic horn will often have one or more ultrasonic horn tips 112. Booster 108 and ultrasonic horn 110 are ultrasonically connected (directly or via another component) to ultrasonic transducer 106. In the example of FIG. 1, booster 108 is mounted to ultrasonic transducer 106 ultrasonically connecting booster 108 to ultrasonic transducer 106 and ultrasonic horn 110 is mounted to booster 108 ultrasonically connecting ultrasonic horn 110 to booster 108 and thus ultrasonically connecting ultrasonic horn 110 to ultrasonic transducer 106 via booster 108. It should be understood that ultrasonic transducers are also known in the art as ultrasonic converters and these terms used interchangeably. Power supply 104 is controlled by a controller 114 that includes memory 116. It should be understood that controller 114 can be included in power supply 104 or separate from power supply 104. Ultrasonic device 100 will often include an anvil (not shown) on which a work piece to be processed will be supported and contacted by ultrasonic horn tip 112 when it is being processed. For example, if two metal or plastic parts are being welded together, they are supported on the anvil and pressed together by the ultrasonic horn tip during the weld process that also ultrasonically vibrates against one of the parts to ultrasonically weld the two parts together.

The piezoelectric material of ultrasonic transducers can sometimes break, such as by developing cracks in the piezoelectric material. This results in a loss of efficiency and gain of the ultrasonic transducer that would detrimentally affect the ultrasonic process. When a crack develops in the piezoelectric material, there is usually no visual way to detect this without disassembling the ultrasonic transducer, especially when the ultrasonic transducer has a housing. It is thus desirable to detect when the piezoelectric material of the ultrasonic transducer is broken. It is also desirable that an alert be provided when the piezoelectric material of the ultrasonic transducer is detected as being broken.

### SUMMARY

This section provides a general summary of the disclosure, and is not a comprehensive disclosure of its full scope or all of its features.

In accordance with an aspect of the present disclosure, a method of detecting broken piezoelectric material in an ultrasonic transducer of an ultrasonic stack of an ultrasonic device includes comparing a test piezo coupling constant with a baseline piezo coupling constant and determining that the piezoelectric material is broken when the test piezo coupling constant is less than the baseline piezo coupling constant by more than a predetermined amount. The test piezo coupling constant is measured with a test scan of the ultrasonic stack in air performed by a power supply of the ultrasonic device and compared to the baseline piezo coupling constant that was previously measured.

In accordance with an aspect, the baseline piezo coupling constant is established by performing with the power supply of the ultrasonic device a baseline scan of the ultrasonic stack in air when the piezoelectric material of the ultrasonic transducer is known to be good and measuring the baseline piezo coupling constant with the baseline scan of the ultrasonic stack. In accordance with an aspect, baseline piezo coupling constant is stored in memory of a controller as the baseline piezo coupling constant and the controller compares the test piezo coupling constant to the baseline piezo coupling constant and determines that the piezoelectric material is broken when the test piezo coupling constant is less than the baseline piezo coupling constant by more than the predetermined amount. In accordance with an aspect, the controller provides an alert upon determining that the piezoelectric material is broken.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified diagram of a typical prior art ultrasonic device;

FIG. 2 is a chart showing a typical prior art scan of an ultrasonic stack of the ultrasonic device of FIG. 1; and

FIG. 3 is a flow chart of a control routine in accordance with an aspect of the present disclosure for detecting whether piezoelectric material of an ultrasonic transducer of an ultrasonic device is broken.

Corresponding reference numerals indicate corresponding parts throughout the several views of the drawings.

### DETAILED DESCRIPTION

Example embodiments will now be described more fully with reference to the accompanying drawings.

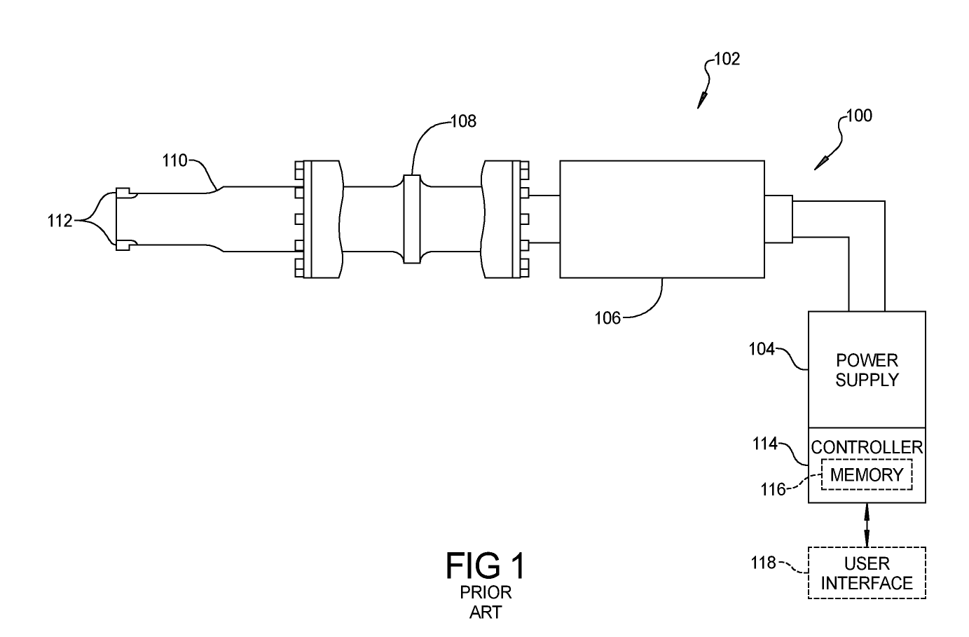

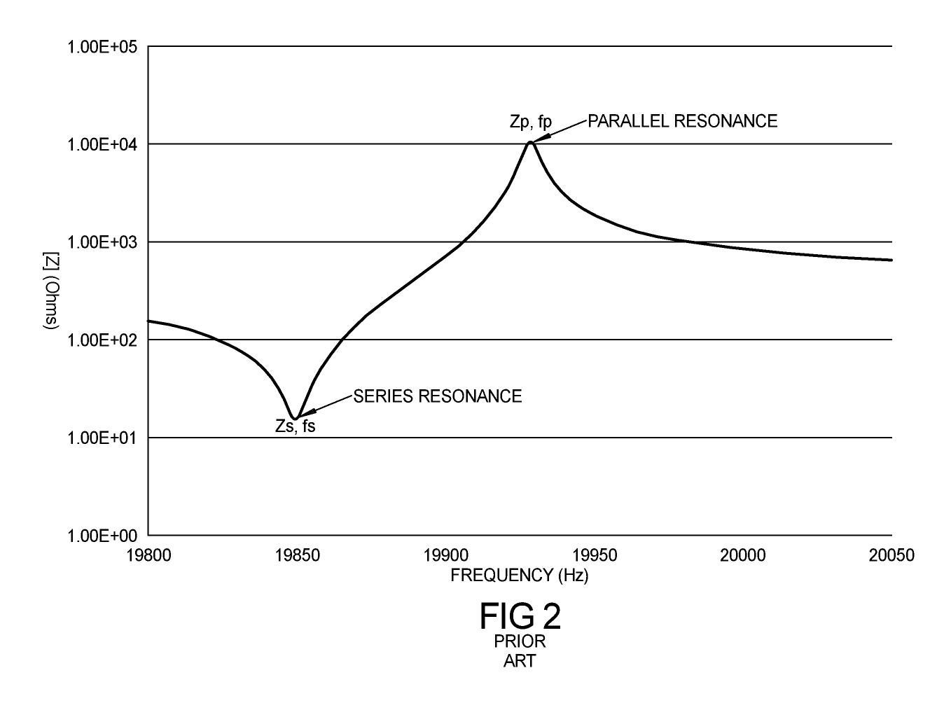

The following discussion will be with reference to ultrasonic device 100 of FIG. 1, but it should be understood that the following applies to any ultrasonic device that has an ultrasonic stack excited by a power supply. In this regard, it should be understood that the method of detecting that piezoelectric material of ultrasonic transducer 106 is broken in accordance with an aspect of the present disclosure as described below differs from methods used in prior art ultrasonic devices and the indication that FIGS. 1 and 2 are prior art does not mean that the below described method is in the prior art.

In accordance with an aspect of the present disclosure, a piezo coupling coefficient K_{Z} is measured to determine if the piezoelectric material of ultrasonic transducer 106 is broken. As is known in the art, the piezo coupling coefficient describes the effectiveness by which the piezoelectric material of the ultrasonic transducer converts electrical energy to mechanical energy and vice-versa. The piezo coupling coefficient K_{Z} is measured with a scan of ultrasonic stack 102 by power supply 104, as discussed in more detail below. More specifically, when ultrasonic transducer 106 is to be checked to determine if its piezoelectric material is broken, piezo coupling coefficient K_{Z} is measured with a test scan of ultrasonic stack 102. This piezo coupling coefficient K_{Z} is compared to a piezo coupling coefficient K_{Z} previously measured with a baseline scan of ultrasonic stack 102. The piezo coupling coefficient K_{Z} measured with the test scan is referred to herein as test piezo coupling coefficient K_{Zt} and the piezo coupling coefficient K_{Z} measured with baseline scan is referred to herein as the baseline piezo coupling coefficient K_{Zb}. If the test piezo coupling coefficient K_{Zt} is less than the baseline test piezo coupling coefficient K_{Zt} by more than a predetermined amount, the piezoelectric material of ultrasonic transducer is determined to be broken.

The piezo coupling coefficient K_{Z} is measured using certain parameters measured during the scan of ultrasonic stack 102 and is calculated using these measured parameters. As used herein, a scan of ultrasonic stack 102 is a frequency sweep of the ultrasonic stack 102 by power supply 104 in which the voltage and current delivered to the ultrasonic transducer 106 at each frequency in the frequency sweep are measured. The frequency steps of the frequency sweep depend on the fidelity that is desired with 1 Hz frequency steps being typical. As can be seen in FIG. 2, a typical scan of ultrasonic stack 102 will have a parallel resonant frequency, which is at the highest impedance, and a series resonant frequency, which is the lowest impedance at a frequency below the parallel resonance. The frequency sweep is through a frequency range that includes the parallel resonant frequency and series resonant frequency, and the range can be determined heuristically for the ultrasonic transducer 106 or theoretically. A frequency range of +/−10% of the nominal frequency of the ultrasonic transducer 106 will usually suffice.

The piezo coupling coefficient K_{Z} is calculated from the information from the scan by:

$${K}_{Z} = \frac{{V}_{nom}}{{G}_{S} ⋆ {x}_{0}} ⋆ \sqrt{\frac{π}{π ⋆ {f}_{P} ⋆ {f}_{S} ⋆ {Z}_{P} ⋆ {Z}_{S}}} \qquad ( 1 )$$

where:
K_{Z} is the piezo coupling coefficient;
Vₙₒₘ is nominal voltage of the power supply;
G_{S} is gain of the ultrasonic stack;
x₀ is nominal amplitude of the ultrasonic transducer;
η is efficiency of the ultrasonic transducer;
f_{P} is parallel resonant frequency of the ultrasonic stack;
f_{S} is series resonant frequency of the ultrasonic stack;
Z_{P} is impedance at parallel resonance (V_{P}/I_{P}));
Z_{S} is impedance at series resonance (V_{S}/I_{S})
V_{P} is voltage of the power supply at parallel resonance (measured parameter);
I_{P} is current of the power supply at parallel resonance (measured parameter);
V_{S} is voltage of the power supply at series resonance (measured parameter);
I_{S} is current of the power supply at series resonance (measured parameter).
   The efficiency of the ultrasonic transducer is calculated from the frequency scan by:

$$η = ( 1 - \frac{2}{π} ⋆ cot ( \frac{π ⋆ ( {f}_{P} - {f}_{S} )}{2 ⋆ {f}_{P}} ) ⋆ tan δ ) ⋆ ( 1 - \frac{{f}_{P}^{2} - {f}_{S}^{2}}{2 π ⋆ {f}_{P} ⋆ {f}_{S}} ⋆ \sqrt{\frac{{Z}_{S}}{{Z}_{P}}} ) \qquad ( 2 )$$

where:

tan δ=piezo loss coefficient.

It should be understood that the parameters identified above as being measured parameters are measured by power supply 104 using sensors with which power supply 104 is configured in a known manner.

In accordance with an aspect of the present disclosure, baseline piezo coupling constant K_{Zb} is established by power supply 104 under control of controller 114 performing a baseline scan of ultrasonic stack 102 in air with a good ultrasonic transducer and controller 114 measuring piezo coupling constant K_{Z} with this baseline scan with this piezo coupling constant K_{Z} set as the baseline piezo coupling constant K_{Zb}. This baseline scan is for example performed during the original assembly of ultrasonic device 100 or when ultrasonic device 100 is first set up for operation such as in a production facility. Thereafter, when it is desired to determine if the piezoelectric material of ultrasonic transducer 106 is broken, a test frequency scan of ultrasonic stack 102 in air is performed by power supply 104 and the test piezo coupling constant K_{Zt} measured by controller 114. If the value of the test piezo coupling constant K_{Zt} is less than the baseline piezo coupling constant K_{Zb} by more than a predetermined amount, controller 114 determines that the piezoelectric material of ultrasonic transducer is broken. In an aspect, controller 114 provides an alert that the piezoelectric material of ultrasonic transducer 104 is broken. By way of example and not of limitation, the alert can be a visual indicator illuminated by controller 114, a message on a screen of a user interface, such as user interface 118 shown in phantom in FIG. 1, a message sent to a remote system monitoring ultrasonic device 100, or any combination of the foregoing.

It should be understood that one or more of the constants in the above equations need not be used in the calculations of the test piezo coupling coefficient K_{Zt} and the baseline piezo coupling coefficient K_{Zb} as long as the calculations used in determining the test piezo coupling coefficient K_{Zt} and the baseline piezo coupling coefficient K_{Zb} use the same constants. For example, Vₙₒₘ, G_{S}, x₀, and tan δ are all constants for a given power supply, ultrasonic stack and ultrasonic transducer and need not be used in the calculations to determine the test piezo coupling coefficient K_{Zt} and the baseline piezo coupling coefficient K_{Zb} for that given power supply, ultrasonic stack and ultrasonic transducer.

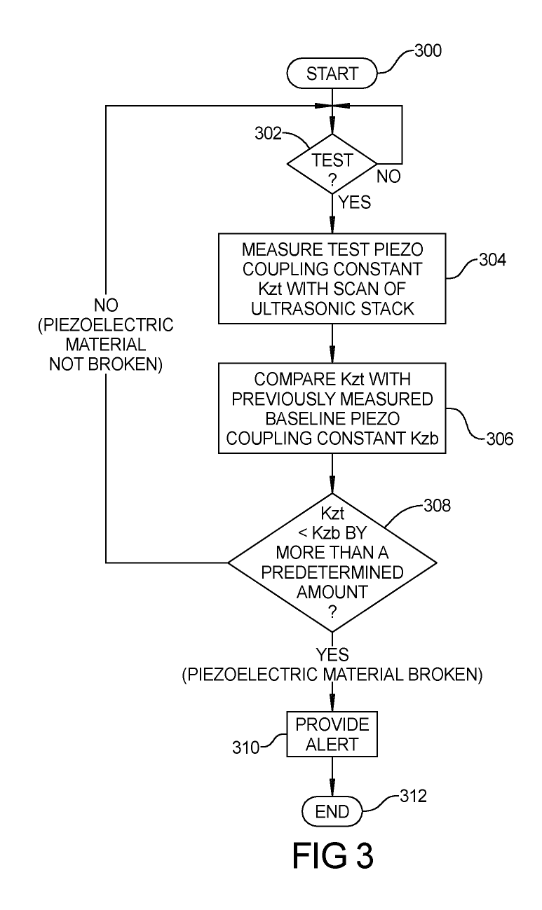

FIG. 3 is a flow chart of a control routine, illustratively implemented in controller 114, for the above described method of detecting whether the piezoelectric material of ultrasonic transducer 106 is broken. The control routine starts at 300. At 302, the control routine checks whether the piezoelectric material of ultrasonic transducer 106 is to be tested to determine if the piezoelectric material is broken. If not, the control routine branches back to 302. If the piezoelectric material is to be tested, the control routine proceeds to 304 where test piezo coupling constant K_{Zt} is measured with a scan of ultrasonic stack 102 in air as described above. The control routine then proceeds to 306 where it compares the test piezo coupling constant K_{Zt} to the previously measured baseline piezo coupling constant K_{Zb} and proceeds to 308. At 308, the control routine checks whether the test piezo coupling constant K_{Zt} is less than the baseline piezo coupling constant K_{Zb} by more than a predetermined amount. If not, the control routine determines that the piezo electric material is not broken and branches back to 302. If the test piezo coupling constant K_{Zt} is less than the baseline piezo coupling constant K_{Zb} by more than the predetermined amount, the control routine determines that the piezoelectric material is broken and proceeds to 310 where it provides an alert, as discussed above, and then ends at 312.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

As used herein, the term controller, control module, control system, or the like may refer to, be part of, or include an Application Specific Integrated Circuit (ASIC); an electronic circuit; a combinational logic circuit; a field programmable gate array (FPGA); a processor (shared, dedicated, or group) that executes code; a programmable logic controller, programmable control system such as a processor based control system including a computer based control system, a process controller such as a PID controller, or other suitable hardware components that provide the described functionality or provide the above functionality when programmed with software as described herein; or a combination of some or all of the above, such as in a system-on-chip. The term module may include memory (shared, dedicated, or group) that stores code executed by the processor. When it is stated that such a device performs a function, it should be understood that the device is configured to perform the function by appropriate logic, such as software, hardware, or a combination thereof.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A method of detecting broken piezoelectric material in an ultrasonic transducer of an ultrasonic stack of an ultrasonic device, comprising:
performing with a power supply of the ultrasonic device a test scan of the ultrasonic stack in air, measuring a test piezo coupling constant with the test scan of the ultrasonic stack, comparing the test piezo coupling constant with a previously measured baseline piezo coupling constant and determining that the piezoelectric material is broken when the test piezo coupling constant is less than the baseline piezo coupling constant by more than a predetermined amount.

2. The method of claim 1 including establishing the baseline piezo coupling constant by performing with the power supply of the ultrasonic device a baseline scan of the ultrasonic stack in air when the piezoelectric material of the ultrasonic transducer is known to be good and measuring the baseline piezo coupling constant with the baseline scan of the ultrasonic stack.

3. The method of claim 2 including storing the baseline piezo coupling constant in memory of a controller as the baseline piezo coupling constant and having the controller compare the test piezo coupling constant to the baseline piezo coupling constant and determine that the piezoelectric material is broken when the test piezo coupling constant is less than the baseline piezo coupling constant by more than the predetermined amount.

4. The method of claim 3 including having the controller provide an alert upon determining that the piezoelectric material is broken.
